(19) United States
(12) Patent Application Publication
(10) Pub. No.: US 2013/0105079 A1
(43) Pub. Date: May 2, 2013

(54) METHOD FOR PRODUCING A MECHANICAL MEMBER FROM COMPOSITE MATERIAL, HAVING AN IMPROVED MECHANICAL PERFORMANCE UNDER TRACTION-COMPRESSION AND BENDING

(71) Applicants: Richard Masson, Les Loges En Josas (FR); Patrick Dunleavy, Palaiseau (FR)

(72) Inventors: Richard Masson, Les Loges En Josas (FR); Patrick Dunleavy, Palaiseau (FR)

(73) Assignee: MESSIER-BUGATTI-DOWTY, Velizy-Villacoublay (FR)

(21) Appl. No.: 13/637,264

(22) PCT Filed: Mar. 24, 2011
(86) PCT No.: PCT/EP11/01479

§ 371 Date: Dec. 31, 2012

(30) Foreign Application Priority Data
Mar. 26, 2010 (FR) 1052230

(51) Int. Cl. B32B 38/08

(52) U.S. Cl. CPC B32B 38/08
USPC 156/305

(57) ABSTRACT

The invention relates to a method for manufacturing a mechanical member in composite material, such as a connecting rod (19), comprising successive operations of applying layers of reinforcing fibres braided all about a mandrel, comprising, between two operations of applying layers of braided reinforcing fibres, a step:
of placing at least one element formed of pultruded reinforcing fibres (14″), oriented longitudinally (AX);
and of at least temporary attachment of each pultruded element (14″) to the last layer of braided reinforcing fibres,

and in which a resin is then injected into the various braided layers before this resin is polymerized in order to form a rough connecting rod.

The invention relates to a method for manufacturing in composite material a mechanical member such as a connecting rod of an aircraft undercarriage strut.

### BACKGROUND OF THE INVENTION

It is known practice, notably from patent document FR2932409, to manufacture such a connecting rod based on a mandrel on which one or more carbon fibre layers are braided, being superposed radially on one another.

This assembly is then installed in a mould in order to inject resin into the various layers supported by the mandrel before this resin is polymerized, for example by heating, in order to form a rigid rough connecting rod that can be machined at its interfaces in order to form clevises.

The braiding of the layers of reinforcing fibres is then carried out with a braiding installation that is shown in FIG. 1, being indicated therein by reference number 1. This installation essentially comprises a ring 2 extending in a vertical plane, the axis of revolution AX of this ring therefore being horizontal. This ring 2 supports a set of windings of reinforcing fibres 3, converging on a region situated on the axis AX and offset relative to the plane of the ring.

When the braiding cycle is begun, the mandrel which is indicated by reference number 4 is moved along the axis AX in order to pass through the ring 2 beyond the point of convergence of the fibres. At the same time, the windings supported on the ring 2 by motorized moveable supports are actuated in order to manufacture a sleeve of reinforcing fibres on the outer face of this mandrel 4.

This sleeve covers the mandrel over the whole of its length once it has completely passed through the ring, that is to say once it is situated beyond the point of convergence of the fibres.

The layer of reinforcing fibres is then cut downstream of the mandrel and the mandrel is removed, then replaced behind the ring, in order to pass through it again for the formation of a second layer of reinforcing fibres that is superposed radially on the first.

Thus, as shown schematically in FIG. 2, it is possible to manufacture a general structure comprising, in its central region, the mandrel forming a support for two layers of braided fibres 6, 7, or more, which extend all about the latter and over the whole of its length.

In concrete terms, as shown in FIG. 2, a braided layer comprises, on the one hand, fibres called spool fibres 8 and 9 that are inclined for example at approximately thirty degrees on one side and on the other relative to the axis AX, and, on the other hand, longitudinal fibres 11, parallel to the axis AX, that are held in position by the spool fibres 8 and 9 that interlace them.

In such a connecting rod, it is essentially the longitudinal fibres that withstand the mechanical stresses that occur when the connecting rod is stressed in tension-compression along the axis AX, and when it suffers bending stress about any axis normal to the axis AX.

Because of the tension of the spool fibres necessary for the braiding, and in contrast to the schematic representation of FIG. 3, the longitudinal fibres 11 are actually wavy instead of being straight, which detracts from the level of mechanical stresses that they are capable of withstanding in the direction AX.

This loss of strength in the longitudinal direction is all the greater when the waviness of the longitudinal fibres is high, because the tension applied to the fibres during braiding must itself be considerable in order to make the assembly as compact as possible.

### OBJECT OF THE INVENTION

The object of the invention is to propose a solution to remedy this drawback.

### SUMMARY OF THE INVENTION

Accordingly, the subject of the invention is a method for manufacturing a mechanical member in composite material, such as a connecting rod in composite material, comprising successive operations of applying layers of reinforcing fibres braided all about a mandrel and over all or some of the length of this mandrel while being superposed radially one on top of the other, comprising, between two operations of applying layers of braided reinforcing fibres, a step:
of placing, on the last layer of braided fibres, at least one element formed of pultruded reinforcing fibres, each pultruded element being oriented longitudinally and extending over at least one portion of the length of the mandrel;
and of at least temporary attachment of each pultruded element to the last layer of braided reinforcing fibres,
and in which once all the pultruded elements have been put in place and all the braided layers have been applied, a resin is injected into the various braided layers before the assembly is polymerized in order to form a rough part.

With this solution, the pultruded elements form an assembly of fibres that remain substantially straight after assembly with the braided layers and after injection and polymerization of the resin, which makes it possible to significantly increase the mechanical strength in the longitudinal direction.

A further subject of the invention is a method as defined above, in which each pultruded element is of the solid rod type.

A further subject of the invention is a method as defined above, in which the attachment of each pultruded element applied against one and the same layer of reinforcing fibres is carried out with a product of the adhesive or resin type.

A further subject of the invention is a method as defined above, in which the attachment of each pultruded element applied against one and the same layer of reinforcing fibres is carried out with a binding passed around the assembly formed by the mandrel with the layers that it supports and the pultruded elements to be attached.

A further subject of the invention is a method as defined above, in which several pultruded elements that are evenly spaced relative to one another around the longitudinal direction of the mandrel are applied against one and the same layer of braided fibres.

A further subject of the invention is a method as defined above, in which various pultruded elements are assembled by linking them to one another by one or more transverse bindings in order to form an assembly of the wickerwork type, before this assembly is placed on one and the same layer of reinforcing fibres.

### BRIEF DESCRIPTION OF THE FIGURES

FIG. 1 is a schematic representation showing in perspective a known braiding machine with a mandrel designed to receive a layer of braided fibres;

FIG. 2 is a schematic view in cross section showing the layers forming a known connecting rod made of composite material;

FIG. 3 is a schematic view showing a portion, represented in perspective, of braided reinforcing fibres;

FIG. 4 is a schematic view in cross section of a connecting rod body with cylindrical section manufactured according to the method according to the invention;

FIG. 5 is a schematic view in cross section of a connecting rod body with elliptical section manufactured according to the method according to the invention;

FIG. 6 is a view in perspective of a finished connecting rod made of composite material manufactured with the method according to the invention;

FIG. 7 is a view in longitudinal section of a connecting rod made of composite material manufactured according to the method according to the invention;

FIG. 8 is a schematic view of an assembly of pultruded elements before the placing and attachment on a braided layer.

### DETAILED DESCRIPTION OF THE INVENTION

The idea that is the basis of the invention is to use a manufacturing method by braiding in which prepolymerized or polymerized straight rods, formed of pultruded reinforcing fibres, are incorporated by placing them longitudinally between the consecutive layers of braided fibres. This builds into the connecting rod longitudinal fibres that are perfectly straight and that thereby significantly increase the mechanical strength of the connecting rod in tension-compression and in bending.

The pultruded profiles are section pieces of composite material of constant section manufactured industrially in a continuous process. In concrete terms, the fibres in the form of windings are unwound continually in order to be impregnated with resin before entering a heated spinneret polymerizing or prepolymerizing this resin, so as to continuously form a rigid section piece from which portions of desired length are chopped during production.

These pultruded section pieces take the form notably of solid or hollow rods consisting of parallel straight reinforcing fibres while being bound to one another by the polymerized or prepolymerized resin. The mechanical strength of the pultruded section pieces is considerable along the main axis of the section piece at a very competitive manufacturing cost.

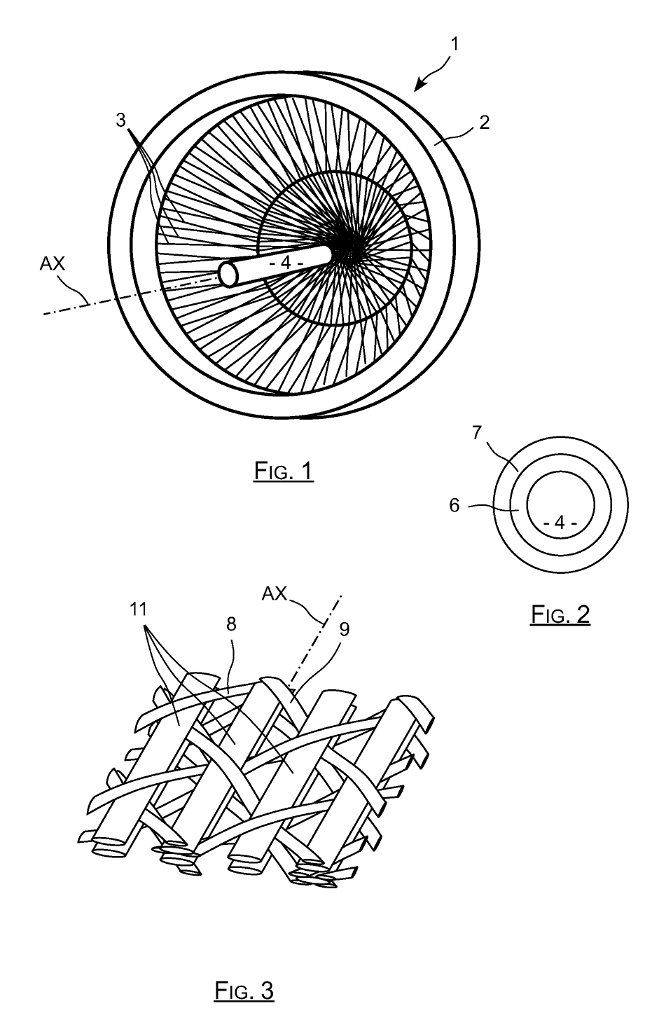

The invention therefore consists in incorporating pultruded elements between the braiding of layers of reinforcing fibres, with an installation like that shown in FIG. 1 in order to manufacture a connecting rod.

As shown schematically in FIG. 4, a connecting rod manufactured according to the invention therefore comprises a mandrel 12, which in this instance has a circular section, about which a layer of reinforcing fibres 13 is braided by passing through a braiding installation like that of FIG. 1.

Once this braid 13 has been applied over the whole length of the mandrel 12, that is to say once the mandrel has traversed the plane of the ring supporting the windings of reinforcing fibres, the installation is stopped. The layer of reinforcing fibres is then cut downstream of the mandrel and the assembly formed by the mandrel 12 and the layer 13 that it supports is removed in order to be installed again upstream of the ring supporting the windings, for the purpose of braiding a new layer of reinforcing fibres.

At this stage, the pultruded elements 14 are placed on the layer 13 so as to extend longitudinally, that is to say parallel to the axis AX of the connecting rod, while being evenly spaced relative to one another about this axis AX. These pultruded elements can be attached by previously applying a product of the adhesive type or else resin to the layer 13.

Another solution relating to the attachment of the pultruded elements consists in surrounding the assembly with a binding of reinforcing fibres so as to clamp these elements against the outer face of the layer 13.

Once the pultruded elements have been put in place and they are held in position in a stable manner, the next layer of reinforcing fibres, indicated by reference number 16, is braided. This braiding is carried out by moving the assembly formed by the mandrel 12, the layer of braided fibres 13, and the pultruded elements 14 through the ring of the braiding installation, along the axis of this ring.

The effect of this operation is to form a layer of braided fibres that then surrounds the pultruded elements 14 by clamping them without significantly changing their position. During the operation of braiding the layer 16, the elements 14 remain oriented longitudinally and evenly spaced relative to one another along the circumference of the layer 13.

In these conditions, and as shown schematically in FIG. 4, the elements 14 are then firmly clamped between the layers 14 and 16 and they are oriented longitudinally along the axis AX.

At this stage, the assembly formed by the mandrel 12, the layers 13 and 16 and the pultruded elements inserted between these layers is installed in a mould in order to inject resin through the layers of reinforcing fibres 14 and 16. If the pultruded section pieces are hollow rods, their ends are blocked to prevent these rods from filling with resin during the injection phase.

A heating cycle is then initiated in order to polymerize this resin so as to form a rigid rough connecting rod of which the interfaces can then be machined by drilling in order to form clevises, and before inserting metal rings in these drillholes.

FIG. 4 shows only an assembly of pultruded elements 14 interposed between two braided layers 13 and 16. But the method according to the invention makes it possible to interpose between each pair of consecutive braided layers an assembly of pultruded elements in order, in general, to increase the mechanical strength in tension-compression and in bending of this connecting rod and thereby its buckling strength.

The pultruded elements 14 do not necessarily have to be distributed over the whole circumference of the braided layer that supports them, but they may advantageously be placed only in certain zones of this circumference, without necessarily being evenly spaced from one another thereon.

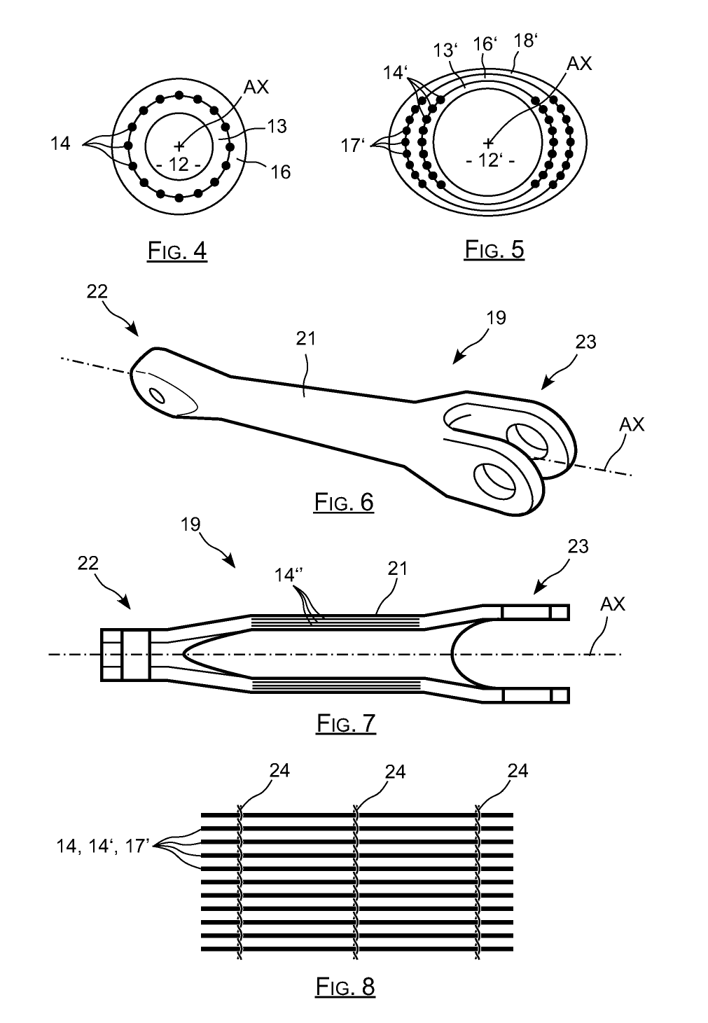

Thus, in the example of FIG. 5, the mandrel 12′ has a section that is elliptical instead of being circular in order to form a connecting rod having increased resistance to bending about the short axis of the ellipse corresponding to its section. The strength in tension-compression also being increased in this connecting rod.

In this case, the first layer 13′ is braided about the mandrel 12′, as for the example of FIG. 4. But pultruded elements 14′ are then placed only on the opposite ends that are the furthest apart of this ellipse so as to increase the strength against a bending stress about the short axis of this ellipse.

The next layer 16′ is then braided, before putting in place other pultruded elements 17′ that are also placed at the ends of this ellipse that are furthest from one another. A new braided layer 18′ is then applied before the injection of resin into the assembly and before its polymerization.

The pultruded elements extend essentially along the body of the connecting rod that is indicated by reference number 21 in FIG. 6 where this connecting rod is shown in its finished state. This body 21 corresponds to the central region of the connecting rod 19, that is a wall of regular type, this body 21 having for example a constant section.

This being so, the pultruded elements can closely follow substantially curved shapes, because their rigidity that is relatively great allows them to follow these shapes while curving as little as possible. In other words, these pultruded elements can be placed on curved shapes and their rigidity ensures that they adopt slightly curved shapes in order to provide a high mechanical strength.

The pultruded elements indicated here by reference number 14″ are placed radially in the form of three layers, but they do not a priori cover the ends 22 and 23 of the connecting rod 21, that is to say the interfaces of this connecting rod, because these ends have greatly evolving, irregular sections that do not lend themselves to the application of straight elements.

Thus, as can be seen in FIG. 7, the pultruded elements 14 are distributed radially over three layers each interposed between two braided layers, but these elements are incorporated into the connecting rod by extending only between the ends 22 and 23 of this connecting rod, forming clevises.

In the examples described in support of FIGS. 4 and 7, the pultruded elements can be applied and held one-to-one on the braided layer that supports them. But advantageously, the pultruded elements 14, 14′, 14″, 17′ can be prepared prior to their application in order to form an assembly of the wickerwork type shown schematically in FIG. 8.

In this case, the pultruded elements are for example placed flat parallel to one another, while being spaced evenly from one another, and they are secured to one another by means of several pairs of reinforcing fibres 24 evenly spaced relative to one another along these elements.

Each pair 24 then comprises two fibres that are generally oriented in a direction perpendicular to the general direction of the pultruded elements, and these two fibres are interlaced about each pultruded element, which makes it possible to secure these elements to one another while keeping them parallel and spaced two-by-two at a predetermined distance.

Placing the pultruded elements on a layer of braided fibres consists in taking hold of the wickerwork thus formed, in applying it to the outer face of the layer in question and in bonding it to the latter, or else in surrounding the assembly with one or more circumferential reinforcing fibre bindings.

In the example of the figures, the connecting rod manufactured according to the method according to the invention comprises two interfaces that in this instance are two clevises. But the invention applies equally to other types of connecting rods such as, for example, the undercarriage bogie beams that comprise an interface at each of their ends and a third interface situated between these ends.

Moreover, the example of the figures illustrates the implementation of the invention for the manufacture of a connecting rod in composite material. But the invention applies to the manufacture of other types of mechanical members, such as for example the manufacture of the carbon blades of an aircraft propeller, or else the manufacture of a carbon mast designed to be fitted to a sailing boat.

Specifically, the blades of a propeller and the mast of a sailing boat are subjected to mechanical stresses that are oriented mainly in their main direction, that is to say the direction of the pultruded elements that are incorporated therein, so that the method according to the invention then provides a significant increase in the mechanical strength for this type of mechanical member.

1. A method for manufacturing a mechanical member in composite material, such as a connecting rod in composite material, comprising successive operations of applying layers of reinforcing fibres braided all about a mandrel and over all or some of the length of this mandrel while being superposed radially one on top of the other, comprising, between two operations of applying layers of braided reinforcing fibres, a step:
of placing, on the last layer of braided fibres, at least one element formed of pultruded reinforcing fibres, each pultruded element being oriented longitudinally and extending over at least one portion of the length of the mandrel;
and of at least temporary attachment of each pultruded element to the last layer of braided reinforcing fibres,
and in which once all the pultruded elements have been put in place and all the braided layers have been applied, a resin is injected into the various braided layers before the assembly is polymerized in order to form a rough part.

2. The method according to claim 1, in which each pultruded element is of the solid rod type.

3. The method according to claim 1, in which the attachment of each pultruded element applied against one and the same layer of reinforcing fibres is carried out with a product of the adhesive or resin type.

4. The method according to claim 1, in which the attachment of each pultruded element applied against one and the same layer of reinforcing fibres is carried out with a binding passed around the assembly formed by the mandrel with the layers that it supports and the pultruded elements to be attached.

5. The method according to claim 1, in which several pultruded elements that are evenly spaced relative to one another around the longitudinal direction of the mandrel are applied against one and the same layer of braided fibres.

6. The method according to claim 1, in which various pultruded elements are assembled by linking them to one another by one or more transverse bindings in order to form an assembly of the wickerwork type, before this assembly is placed on one and the same layer of reinforcing fibres.
